(19) United States
(12) Patent Application Publication
(10) Pub. No.: US 2026/0368534 A1
(43) Pub. Date: Nov. 19, 2026

(54) SYSTEMS AND METHODS FOR TRAINING DEEP NEURAL NETWORKS USING CLIENT DATA

(71) Applicant: Truist Bank, Charlotte, NC (US)

(72) Inventors: Glenn Pinto, Charlotte, NC (US); Thomas Alan Marien, JR., Charlotte, NC (US); Logendran Kannuthurai, Charlotte, NC (US); Tyler Raymond St. John, Charlotte, NC (US)

(73) Assignee: Truist Bank, Charlotte, NC (US)

(21) Appl. No.: 19/209,090

(22) Filed: May 15, 2025

(51) Int. Cl. G06N 3/09; G06F 16/906; G06F 16/93

(52) U.S. Cl. CPC G06N 3/09; G06F 16/906; G06F 16/93

(57) ABSTRACT

A method, computer program product, and computer system for analyzing, by a computing device, a plurality of documents. The plurality of documents may be classified. Data may be extracted from the plurality of documents. The data from the plurality of documents may be compared to a second plurality of documents. Multiple values associated with the data extracted from the plurality of documents may be generated.

### TECHNICAL FIELD

The present disclosure relates to data analysis, and more particularly, to iteratively training a deep neural network using client data.

### BACKGROUND

Artificial intelligence (AI) has become a valuable tool for addressing a wide range of technological needs. For instance, AI may help improve decision-making by providing deep insights from large volumes of data, helping businesses uncover valuable patterns and trends that might not be apparent through manual analysis.

### SUMMARY

In one example implementation, a computer-implemented method, performed by one or more computing devices, may include but is not limited to analyzing, by a computing device, a plurality of documents. The plurality of documents may be classified. Data may be extracted from the plurality of documents. The data from the plurality of documents may be compared to a second plurality of documents. Multiple values associated with the data extracted from the plurality of documents may be generated.

One or more of the following example features may be included. At least a portion of the data may be inputted into a plurality of input fields based upon, at least in part, the data extracted from the plurality of documents. Inputting at least the portion of the data into the plurality of input fields may include mapping at least the portion of the data to the input fields. Analyzing the plurality of documents may include training an artificial intelligence (AI)-based model to extract the data from the plurality of documents. Generating multiple values associated with the data extracted from the plurality of documents may include outputting the multiple values from a neural network (NN). The NN may be iteratively trained using a feedback loop. The NN may be a deep NN.

In another example implementation, a computing system may include one or more processors and one or more memories configured to perform operations that may include but are not limited to analyzing, by a computing device, a plurality of documents. The plurality of documents may be classified. Data may be extracted from the plurality of documents. The data from the plurality of documents may be compared to a second plurality of documents. Multiple values associated with the data extracted from the plurality of documents may be generated.

One or more of the following example features may be included. At least a portion of the data may be inputted into a plurality of input fields based upon, at least in part, the data extracted from the plurality of documents. Inputting at least the portion of the data into the plurality of input fields may include mapping at least the portion of the data to the input fields. Analyzing the plurality of documents may include training an artificial intelligence (AI)-based model to extract the data from the plurality of documents. Generating multiple values associated with the data extracted from the plurality of documents may include outputting the multiple values from a neural network (NN). The NN may be iteratively trained using a feedback loop. The NN may be a deep NN.

In another example implementation, a computer program product may reside on a computer readable storage medium having a plurality of instructions stored thereon which, when executed across one or more processors, may cause at least a portion of the one or more processors to perform operations that may include but are not limited to analyzing, by a computing device, a plurality of documents. The plurality of documents may be classified. Data may be extracted from the plurality of documents. The data from the plurality of documents may be compared to a second plurality of documents. Multiple values associated with the data extracted from the plurality of documents may be generated.

One or more of the following example features may be included. At least a portion of the data may be inputted into a plurality of input fields based upon, at least in part, the data extracted from the plurality of documents. Inputting at least the portion of the data into the plurality of input fields may include mapping at least the portion of the data to the input fields. Analyzing the plurality of documents may include training an artificial intelligence (AI)-based model to extract the data from the plurality of documents. Generating multiple values associated with the data extracted from the plurality of documents may include outputting the multiple values from a neural network (NN). The NN may be iteratively trained using a feedback loop. The NN may be a deep NN.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### DRAWINGS

FIG. 1 is an example diagrammatic view of a value generation process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a value generation process according to one or more example implementations of the disclosure; and

FIG. 4 is an example diagrammatic view of an example DNN according to one or more example implementations of the disclosure.

Like reference symbols in the various drawings indicate like elements.

### DESCRIPTION

### System Overview

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, state information that personalizes electronic circuitry and/or other structural components that are native to hardware (e.g., host processor, central processing unit/CPU, microcontroller, etc.) or either source code or object code written in any combination of one or more programming languages, including an object oriented programming language such as Java^{®}, Smalltalk, C++ or the like. Java^{®} and all Java-based trademarks and logos are trademarks or registered trademarks of Oracle and/or its affiliates. However, the computer program code for carrying out operations of the present disclosure may also be written in conventional procedural programming languages, such as the "C" programming language, PASCAL, or similar programming languages, as well as in scripting languages such as JavaScript, PERL, or Python. The program code may execute entirely on the user's computer, partly on the user's computer, as a stand-alone software package, partly on the user’s computer and partly on a remote computer or entirely on the remote computer or server. In the latter scenario, the remote computer may be connected to the user’s computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), memory chips, network chips, systems on chip (SoCs), SSD/NAND controller ASICs, and the like, etc. may execute the computer readable program instructions/code by utilizing state information of the computer readable program instructions to personalize the electronic circuitry, in order to perform aspects of the present disclosure. Configurable or fixed-functionality logic may be implemented with complementary metal oxide semiconductor (CMOS) logic circuits, transistor-transistor logic (TTL) logic circuits, or other circuits. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an accelerator (e.g., an AI accelerator), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the AI accelerator may include suitable logic, circuitry, and/or interfaces to accelerate artificial intelligence applications, such as, e.g., artificial neural networks, machine vision and machine learning applications, including through parallel processing techniques. In one or more examples, the AI accelerator may include hardware logic or devices such as, e.g., a GPU or an FPGA. The AI accelerator may be used with any of the devices, components, features or methods described herein.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved. In addition, in some of the drawings, signal conductor lines may be represented with lines. Some may be different, to indicate more constituent signal paths, have a number label, to indicate a number of constituent signal paths, and/or have arrows at one or more ends, to indicate primary information flow direction(s). This, however, should not be construed in a limiting manner. Rather, such added detail may be used in connection with one or more implementations to facilitate ease of understanding. Any represented lines, whether or not having additional information, may actually comprise one or more signals/information that may travel in multiple directions and may be implemented with any suitable type of signal scheme, e.g., digital or analog lines implemented with differential pairs, optical fiber lines, and/or single-ended lines, etc.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

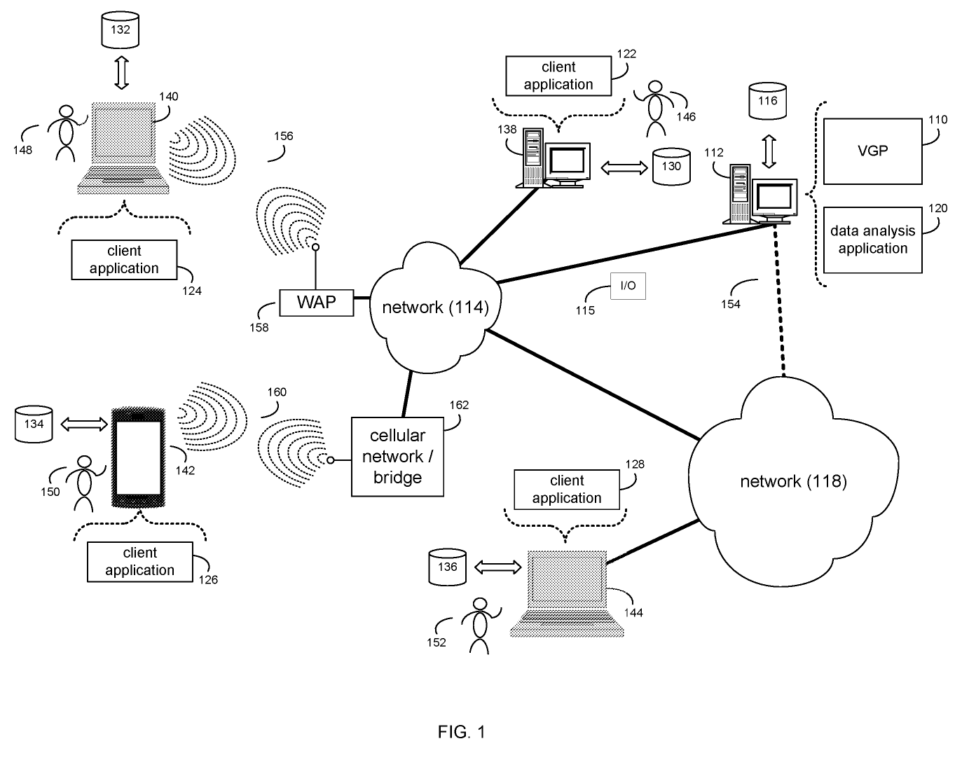

Referring now to the example implementation of FIG. 1, there is shown value generation process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a value generation process, such as value generation process 110 of FIG. 1, may analyze, by a computing device, a plurality of documents. The plurality of documents may be classified. Data may be extracted from the plurality of documents. The data from the plurality of documents may be compared to a second plurality of documents. Multiple values associated with the data extracted from the plurality of documents may be generated.

In some implementations, the instruction sets and subroutines of value generation process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase "telecommunications network facility," as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, value generation process 110 may be a component of the data store, a standalone application that interfaces with the above noted data store and/or an applet / application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a data analysis application (e.g., data analysis application 120), examples of which may include, but are not limited to, e.g., an automatic speech recognition (ASR) application, examples of which may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a predictive analytics application, a machine learning application, an automated underwriting system application, a risk assessment application, a fraud detection application, a customer segmentation and profiling application, a data integration and processing application, a web conferencing application, a video conferencing application, a telephony application, a voice-over-IP application, a video-over-IP application, an Instant Messaging (IM)/"chat" application, a chatbot application, an interactive voice response (IVR) application, a short messaging service (SMS)/multimedia messaging service (MMS) application, or other application that allows for AI based analysis and/or decision making. In some implementations, value generation process 110 and/or data analysis application 120 may be accessed via one or more of client applications 122, 124, 126, 128. In some implementations, value generation process 110 may be a standalone application, or may be an applet / application / script / extension that may interact with and/or be executed within data analysis application 120, a component of data analysis application 120, and/or one or more of client applications 122, 124, 126, 128. In some implementations, data analysis application 120 may be a standalone application, or may be an applet / application / script / extension that may interact with and/or be executed within value generation process 110, a component of value generation process 110, and/or one or more of client applications 122, 124, 126, 128. In some implementations, one or more of client applications 122, 124, 126, 128 may be a standalone application, or may be an applet / application / script / extension that may interact with and/or be executed within and/or be a component of value generation process 110 and/or data analysis application 120. Examples of client applications 122, 124, 126, 128 may include, but are not limited to, e.g., a VR application, XR or MR application, an AR application, an automatic speech recognition (ASR) application, examples of which may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a predictive analytics application, a machine learning application, an automated underwriting system application, a risk assessment application, a fraud detection application, a customer segmentation and profiling application, a data integration and processing application, a web conferencing application, a video conferencing application, a telephony application, a voice-over-IP application, a video-over-IP application, an Instant Messaging (IM)/"chat" application, a chatbot application, an interactive voice response (IVR) application, a short messaging service (SMS)/multimedia messaging service (MMS) application, or other application that allows for AI based analysis and/or decision making, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a laptop computer (e.g., client electronic device 140), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android^{TM}, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of value generation process 110 (and vice versa). Accordingly, in some implementations, value generation process 110 may be a purely server-side application, a purely client-side application, or a hybrid server-side / client-side application that is cooperatively executed by one or more of client applications 122, 124, 126, 128 and/or value generation process 110.

In some implementations, one or more of client applications 122, 124, 126, 128 may be configured to effectuate some or all of the functionality of data analysis application 120 (and vice versa). Accordingly, in some implementations, data analysis application 120 may be a purely server-side application, a purely client-side application, or a hybrid server-side / client-side application that is cooperatively executed by one or more of client applications 122, 124, 126, 128 and/or data analysis application 120. As one or more of client applications 122, 124, 126, 128, value generation process 110, and data analysis application 120, taken singly or in any combination, may effectuate some or all of the same functionality, any description of effectuating such functionality via one or more of client applications 122, 124, 126, 128, value generation process 110, data analysis application 120, or combination thereof, and any described interaction(s) between one or more of client applications 122, 124, 126, 128, value generation process 110, data analysis application 120, or combination thereof to effectuate such functionality, should be taken as an example only and not to limit the scope of the disclosure.

In some implementations, one or more of users 146, 148, 150, 152 may access computer 112 and value generation process 110 (e.g., using one or more of client electronic devices 138, 140, 142, 144) directly through network 114 or through network 118. Further, computer 112 may be connected to network 114 through network 118, as illustrated with phantom link line 154. Value generation process 110 may include one or more user interfaces, such as browsers and textual or graphical user interfaces, through which users 146, 148, 150, 152 may access value generation process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth^{TM} (including Bluetooth^{TM} Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network / bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth^{TM} (including Bluetooth^{TM} Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third-party offering software as a service (SaaS), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

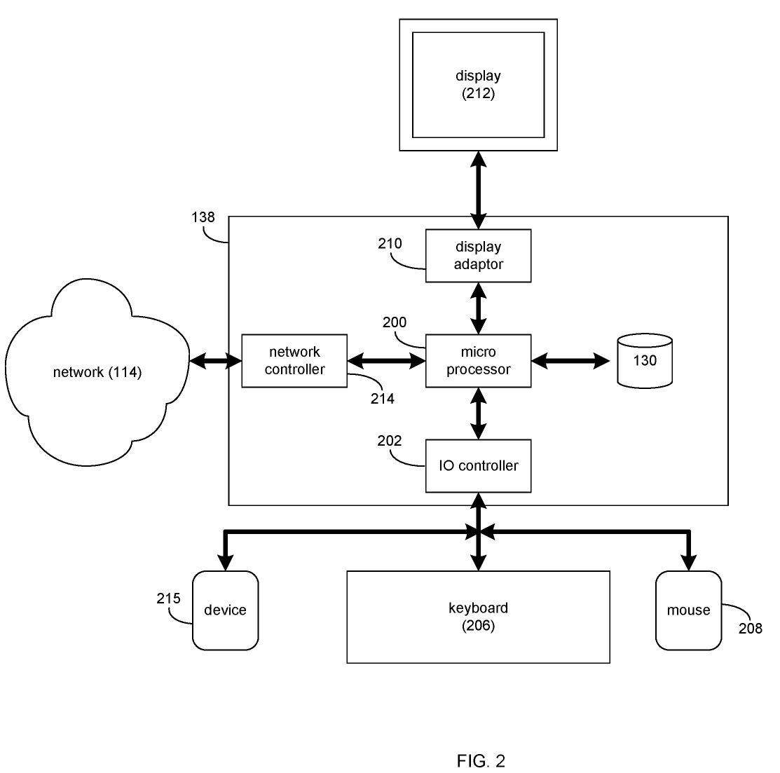

Referring also to the example implementation of FIG. 2, there is shown a diagrammatic view of client electronic device 138. While client electronic device 138 is shown in this figure, this is for example purposes only and is not intended to be a limitation of this disclosure, as other configurations are possible. Additionally, any computing device capable of executing, in whole or in part, value generation process 110 may be substituted for client electronic device 138 (in whole or in part) within FIG. 2, examples of which may include but are not limited to computer 112 and/or one or more of client electronic devices 140, 142, 144.

In some implementations, client electronic device 138 may include a processor (e.g., microprocessor 200) configured to, e.g., process data and execute the above-noted code / instruction sets and subroutines. Microprocessor 200 may be coupled via a storage adaptor to the above-noted storage device(s) (e.g., storage device 130). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), scanner, custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

### The Value Generation Process

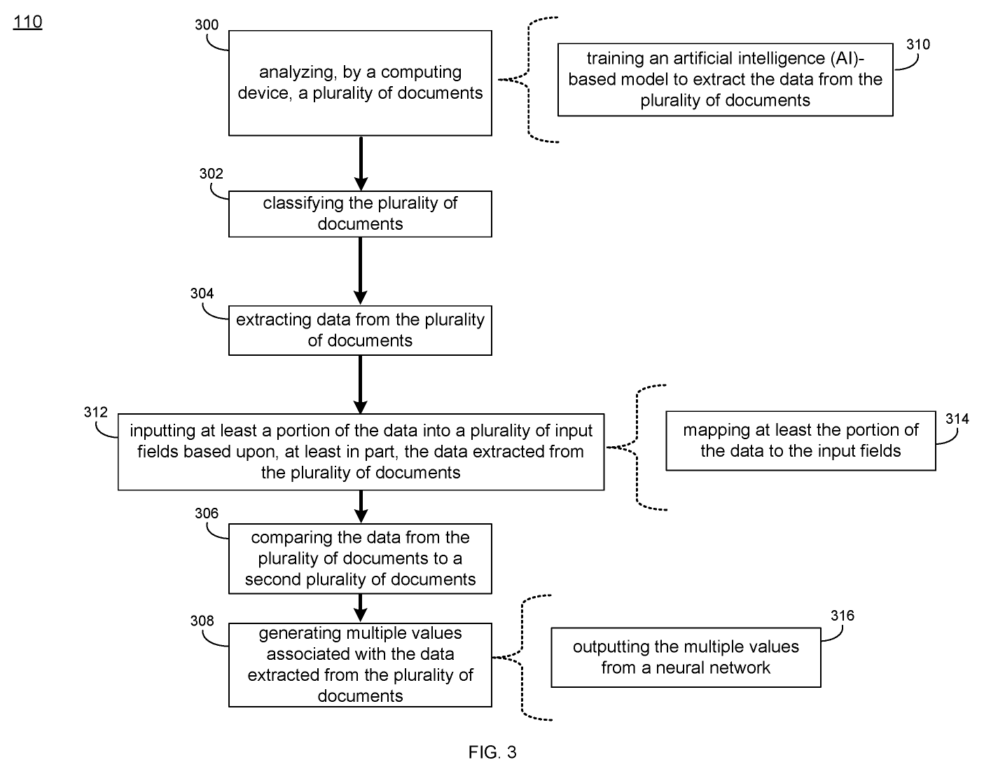

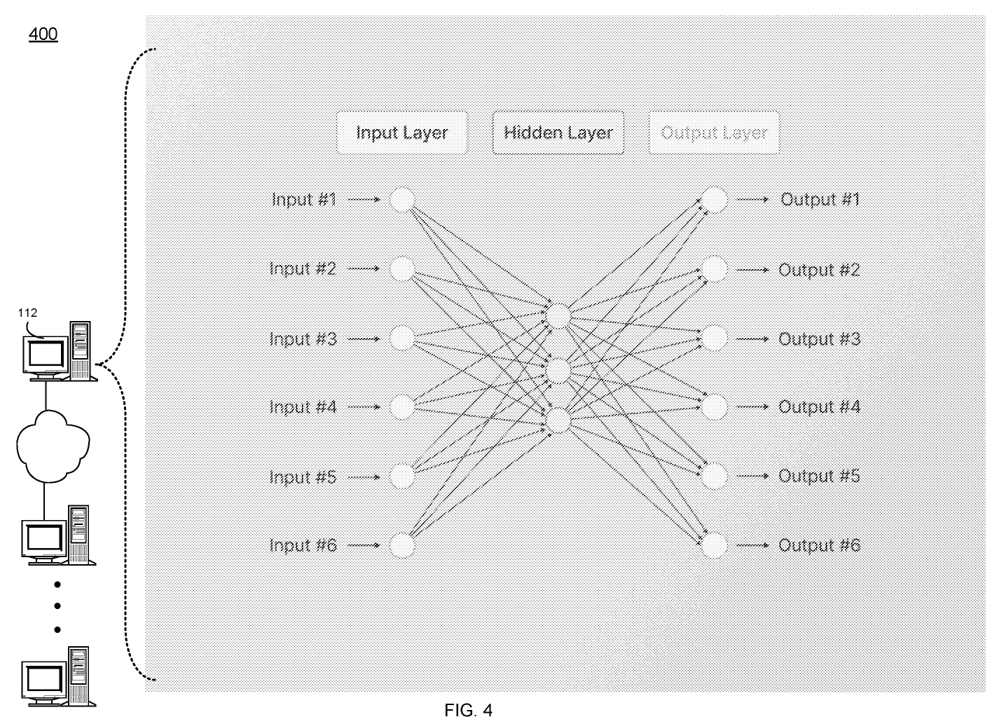

As discussed above and referring also at least to the example implementations of FIGS. 3-4, value generation process (VGP) 110 may analyze 300, by a computing device, a plurality of documents. VGP 110 may classify 302 the plurality of documents. VGP 110 may extract 304 data from the plurality of documents. VGP 110 may compare 306 the data from the plurality of documents to a second plurality of documents. VGP 110 may generate 308 multiple values associated with the data extracted from the plurality of documents.

In some implementations, VGP 110 may analyze 300, by a computing device, a plurality of documents, and in some implementations, VGP 110 may classify 302 the plurality of documents. For instance, in some implementations, VGP 110 may analyze a plurality of documents specifically tailored to premium finance quoting workflows (although other workflows may be used). This structured analysis begins with document preprocessing, where text is extracted from documents such as insurance binders using, e.g., Optical Character Recognition (OCR) when they are scanned or image-based. The extracted text may be cleaned and normalized to remove noise and standardize data. Key features, including insured names, policy numbers, premium amounts, effective dates, carrier information, and other relevant details, are identified and converted into numerical or structured representations using methods such as TF-IDF or word embeddings. Natural language processing (NLP) techniques interpret the context of information relevant to premium finance quoting, and pattern recognition algorithms detect specific formats like policy numbers, premium amounts, and effective dates.

These documents are then classified into predefined categories relevant to premium finance quoting, such as "Insurance Binder Processing" and "Premium Finance Quoting Verification." For example, an insurance binder containing details such as insured name, policy number, premium amount, effective dates, and carrier information might be classified under "Insurance Binder Processing," while documents requiring further validation for quote suitability may fall under "Premium Finance Quoting Verification." Classification may use machine learning models trained on labeled datasets of similar insurance documents. Confidence scores indicate classification certainty, with lower-confidence documents flagged for human review. Rule-based refinement ensures that specific premium finance quoting criteria, like verifying complete policy details, are met. Once classified, documents are indexed and stored with premium finance-specific metadata tags, facilitating efficient retrieval during premium finance quote generation.

In some implementations, VGP 110 may compare 306 the data from the plurality of documents to a second plurality of documents, where VGP 110 may generate 308 multiple values associated with the data extracted from the plurality of documents. For instance, in some implementations, VGP 110 compares data extracted from insurance binders to predefined premium finance policies to generate multiple premium finance quotes. VGP 110 ingests and digitizes policy documents detailing finance rates, down payment requirements, repayment terms, and eligibility criteria. For instance, a premium finance policy may specify a financing rate for premiums exceeding a certain amount and meeting underwriting standards. VGP 110 aligns extracted binder data—such as premium amount and insured information—with these criteria. If an insurance binder has a premium amount of $25,000 and meets underwriting conditions, VGP 110 generates multiple quotes detailing finance terms, down payments, repayment schedules, and specific conditions.

Using a specialized rule-based engine, VGP 110 evaluates binder details against premium finance policy terms, generating quotes specifying financed premium amounts, interest rates, down payments, repayment terms, and unique premium finance conditions. For example, quotes might include options financing the premium over 10 months at one interest rate or 12 months at another. VGP 110 optimizes these quotes, highlighting options like lower down payments or favorable repayment terms. Quotes, along with confidence scores related to underwriting accuracy, are presented via a user interface for review by agents or applicants.

In some implementations, generating multiple values associated with the data extracted from the plurality of documents may include outputting 316 the multiple values from a neural network (NN), and in some implementations, the NN may be a deep NN (DNN). For instance, in some implementations, generating multiple premium finance quotes includes outputting the values from a DNN to analyze, classify, and compare insurance binder documents, generating quotes by modeling complex relationships within the data. Raw text from binders is processed by initial neural network layers, where the initial layers—often composed of convolutional neural networks (CNNs) or recurrent neural networks (RNNs) like Long Short-Term Memory (LSTM) or Gated Recurrent Units (GRUs)—automatically extract features such as policy numbers, premium amounts, and carrier information. For example, the DNN recognizes terms like "premium amount" or "effective date" and associates them with numerical values required for quote generation.

Deeper layers of the DNN perform document classification tasks, assigning documents to categories like "Insurance Binder Processing" or "Premium Finance Quoting Verification." The DNN maps extracted features based on training data to classify binders containing required details clearly. Attention mechanisms within the network may evaluate extracted data against premium finance criteria such as minimum premium amounts and effective date accuracy.

Based on these evaluations, the DNN generates multiple premium finance quotes, varying parameters like loan amount, interest rate, and repayment terms according to policy matches. For instance, outputs could include quotes for financing a $25,000 premium over 10 months at one rate or 12 months at another. Optimization layers within the DNN prioritize criteria like lowest overall cost or highest approval likelihood. Generated quotes, including confidence scores or rankings, help applicants or loan officers make informed decisions.

In some implementations, the neural network is iteratively trained using a feedback loop, continuously refining based on performance in real-world premium finance quote generation. Initially trained on labeled datasets of insurance binder examples, the network learns to extract features, classify documents, and generate accurate premium finance quotes. Feedback collected on actual quote acceptance and document classification accuracy is integrated into the training data, particularly correcting instances of inaccuracies. The DNN undergoes regular retraining to adapt to evolving policies, document formats, and underwriting guidelines.

This iterative training employs techniques like adaptive learning rates and regularization methods to fine-tune the neural network, preventing overfitting and ensuring adaptability. With each iteration, the network becomes more accurate and robust in extracting binder details, classifying documents, matching premium finance criteria, and generating competitive quotes.

Adaptive learning rates and regularization are example techniques in training DNNs to ensure effective learning and to prevent overfitting. Adaptive learning rates dynamically adjust the learning rate during training, allowing the model to make more refined updates. Techniques like AdaGrad, RMSprop, and Adam may be used. AdaGrad adapts the learning rate based on the history of gradients, making larger adjustments for less frequently updated parameters, while RMSprop introduces a decay factor to prevent the learning rate from becoming too small over time. Adam combines the benefits of both by maintaining moving averages of past gradients and their squares, which allows for more nuanced adjustments tailored to each parameter's needs. Regularization techniques, on the other hand, help prevent overfitting by adding constraints to the model's learning process. L2 regularization discourages the model from placing too much importance on any single feature by adding a penalty proportional to the square of the model's weights, leading to smaller, more distributed weights. L1 regularization promotes sparsity by penalizing the absolute value of the weights, often resulting in some weights being driven to zero, which effectively performs feature selection. VGP 110 may also use Dropout as a regularization method, where randomly selected neurons are ignored during training, forcing the network to develop robust features that are not overly dependent on any particular neuron. Batch normalization, while primarily used to stabilize and accelerate training, also contributes to regularization by normalizing the input to each layer, reducing the network’s sensitivity to small changes in the data. Together, these techniques ensure that the DNN not only learns efficiently from the training data but also generalizes well to new, unseen data, leading to a more robust and reliable model.

Referring at least to the example implementation of FIG. 4, an example DNN 400 is shown. In the example, there is an input layer, a hidden layer, and an output layer. Each node in the input layer could represent different pieces of information extracted from the documents. For instance, input nodes may represent premium finance-specific information such as insured names, policy numbers, premium amounts, effective and expiration dates, carrier information, and endorsements.

Hidden layers capture complex relationships specific to premium finance quoting, evaluating extracted binder completeness, consistency of coverage information, and the risk of non-compliance with premium finance underwriting guidelines.

Output layers represent various premium finance quotes or decisions tailored to the extracted binder data, including financed premium amount, suggested interest rates, down payment requirements, repayment terms, and monthly installment estimates.

The DNN processes structured binder data, evaluates underwriting eligibility and risk, and outputs customized premium finance quotes or recommendations optimized for applicant or agent selection.

VGP 110 systematically extracts premium finance-specific data from binders through database requests, structured queries, and rules engines, evaluating eligibility criteria such as premium amounts and underwriting conditions to determine quoting eligibility.

As noted above, in some implementations, VGP 110 may extract 304 data from the plurality of documents. For instance, VGP 110 may input 312 at least a portion of the data into a plurality of input fields based upon, at least in part, the data extracted from the plurality of documents, and in some implementations, inputting at least the portion of the data into the plurality of input fields may include mapping 314 at least the portion of the data to the input fields. Extracted data may be mapped to corresponding input fields required for DNN evaluation, ensuring data integrity and reliable quote decision-making. For instance, the API of VGP 110 may extract data from documents (or other data) in the database through a systematic process involving request handling, database connection, query construction, data retrieval, data transformation, rule evaluation, response construction, and response delivery. When a client application (e.g., via VGP 110 may) sends a request to the API, such as evaluating eligibility for a customer, it may include specific parameters. The API then establishes a connection to the database, utilizing database drivers or ORM tools for efficient access. In the example, VGP 110 may may construct a query based on the request parameters for a NoSQL database like MongoDB, specifying which documents or data fields to retrieve. In some implementations, the query may be executed against the database, and the required data is retrieved. This data may be transformed into a structured format, such as JSON, suitable for a rules engine. For example, database records may be converted into a JSON object containing customer information

Rule-based evaluations verify extracted data compliance with premium finance requirements, generating decisions like eligibility for specific financing options.

In some implementations, VGP 110 may run a plurality of rules on at least the portion of the data input into the plurality of input fields, and in some implementations, VGP 110 may may return a decision based upon, at least in part, running the plurality of rules on at least the portion of the data input into the plurality of input fields. For instance, with the above-noted input fields properly assigned to the extracted data, VGP 110 may evaluate the ruleset. For instance, expression trees may be used to dynamically evaluate premium finance-specific rules, efficiently determining eligibility based on binder details like premium amounts and policy accuracy. For example, instead of a straightforward procedural evaluation, the rules may be represented as an expression tree (e.g., in the .NET framework). An expression tree may be described as a hierarchical structure where each node represents an operation (like AND, OR, NOT) or an operand (like specific values or variables). For instance, a rule might be represented as an expression tree with nodes for conditions. During the evaluation, VGP 110 traverses this expression tree. Starting from the root node, it evaluates each sub-expression by recursively evaluating its child nodes. If a node represents an operation, the engine evaluates its operands (child nodes) and applies the operation. For example, for the root node representing an AND operation, it would evaluate whether both child nodes are true. The results of these evaluations determine the outcome of the rule. If all conditions are satisfied, the expression tree evaluation returns true, triggering the corresponding action. The final output, based on the expression tree's evaluation, might be a JSON object, which the rules engine then sends as the response. Using an expression tree allows for more dynamic and flexible rule evaluation, particularly when dealing with complex, nested conditions. It also facilitates optimizations such as short-circuit evaluation, where the engine can stop evaluating as soon as it determines the overall expression's outcome. This ensures efficient, accurate decision-making based on the structured data input

In some implementations, analyzing the plurality of documents may include training 310 an artificial intelligence (AI)-based model to extract the data from the plurality of documents for automatic quote generation. For instance, AI-based models are trained explicitly for premium finance document analysis, automating extraction of critical binder information, continuously improving accuracy through iterative feedback loops and retraining, ensuring robust and efficient premium finance quote generation. For instance, a diverse set of documents, such as those described above, may be collected and annotated with relevant labels identifying key information. These documents may then be preprocessed using Optical Character Recognition (OCR) to convert them into machine-readable text, followed by cleaning to remove noise and normalizing the data for consistency. The text may be tokenized into words and phrases, which the AI model can process. Key features for loan decisioning are identified, and training features are developed to help the model learn to recognize these features. In some implementations, pre-trained models suitable for natural language processing and document understanding may be selected and fine-tuned on the annotated dataset to adapt them to the specific context of loan document analysis. The models are trained using the labeled data, employing techniques like supervised learning, and their performance is evaluated using metrics such as precision, recall, F1 score, and accuracy. This process may include error analysis to identify common mistakes and iteratively improve the model. Once trained, the models are integrated into VGP 110 may through APIs, enabling automated extraction and decision-making. In some implementations, a feedback loop may be established where human reviews of the model's predictions provide additional labeled data for retraining, ensuring continuous improvement and adaptation to evolving document formats and criteria. This comprehensive approach ensures that AI-based document models can effectively automate the extraction of critical information from loan documents, enhancing the accuracy and efficiency of the loan decision-making process.

The terminology used herein is for the purpose of describing particular implementations only and is not intended to be limiting of the disclosure. As used herein, the singular forms "a", "an" and "the" are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms "comprises" and/or "comprising," when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set — in other words, in some circumstances a “set” may have zero elements. The term “non-empty set” may be used to indicate exclusion of the empty set — that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set — in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A method, comprising:
analyzing, by a computing device, a plurality of documents;
classifying the plurality of documents;
extracting data from the plurality of documents;
comparing the data from the plurality of documents to a second plurality of documents; and
generating multiple values associated with the data extracted from the plurality of documents.

2. The method of claim 1, further comprising inputting at least a portion of the data into a plurality of input fields.

3. The method of claim 2, further comprising applying a plurality of rules to at least the portion of the data input into the plurality of input fields.

4. The method of claim 2, wherein inputting at least the portion of the data into the plurality of input fields is based upon, at least in part, the data extracted from the plurality of documents.

5. The method of claim 4, wherein inputting at least the portion of the data into the plurality of input fields includes mapping at least the portion of the data to the input fields.

6. The method of claim 1, wherein analyzing the plurality of documents includes training an artificial intelligence (AI)-based model to extract the data from the plurality of documents.

7. The method of claim 1, wherein generating multiple values associated with the data extracted from the plurality of documents includes outputting the multiple values from a neural network (NN).

8. The method of claim 7, wherein the NN is iteratively trained using a feedback loop.

9. The method of claim 8, wherein the NN is iteratively trained on labeled datasets as training data to extract features, classify documents, and generate one or more quotes.

10. The method of claim 9, further comprising correcting instances of inaccuracies by integrating feedback collected on actual quote acceptance and document classification accuracy into the training data.

11. The method of claim 7, wherein the NN comprises a deep NN (DNN).

12. The method of claim 11, further comprising retraining the DNN to adapt to evolving policies, document formats, and underwriting guidelines.

13. The method of claim 11, wherein deeper layers of the DNN perform document classification tasks and assign the plurality of documents to categories.

14. The method of claim 13, wherein the DNN maps extracted features from the extracted data.

15. The method of claim 14, wherein the DNN maps extracted features from the extracted data based on training data to classify the document.

16. The method of claim 11, wherein the DNN comprises an input layer, a hidden layer, and an output layer.

17. The method of claim 11, wherein each node in the input layer represents different pieces of information extracted from the documents.

18. The method of claim 1, wherein extracting data from the plurality of documents is performed by an application programming interface (API).

19. A computer program product residing on a computer readable storage medium having a plurality of instructions stored thereon which, when executed across one or more processors, causes at least a portion of the one or more processors to perform operations comprising:
analyzing a plurality of documents;
classifying the plurality of documents;
extracting data from the plurality of documents;
comparing the data from the plurality of documents to a second plurality of documents; and
generating multiple values associated with the data extracted from the plurality of documents.

20. A computing system including one or more processors and one or more memories configured to perform operations comprising:
analyzing a plurality of documents;
classifying the plurality of documents;
extracting data from the plurality of documents;
comparing the data from the plurality of documents to a second plurality of documents; and
generating multiple values associated with the data extracted from the plurality of documents.
